(19) United States
(12) Patent Application Publication
(10) Pub. No.: US 2012/0036076 A1
(43) Pub. Date: Feb. 9, 2012

(54) PREPAID DISTRIBUTION APPLICATION AND DEVICE

(76) Inventors: Jennifer Vanderwall, Wilton, CT (US); Daniel Cohen, New York, NY (US)

(21) Appl. No.: 13/198,858

(22) Filed: Aug. 5, 2011

Related U.S. Application Data
(60) Provisional application No. 61/371,422, filed on Aug. 6, 2010.

(51) Int. Cl. G06Q 30/06; H04L 9/28

(52) U.S. Cl. 705/75

(57) ABSTRACT

A method comprising includes receiving an encrypted over-the-air message from a mobile wireless device requesting that the balance of a merchant's prepayment account for a distributor be reloaded by a requested amount, where the mobile wireless device stores the balance in a secure element holding data encrypted by a key, authorizing a reload of the merchant's prepayment account for the distributor, transmitting an encrypted over-the-air message to the mobile wireless device to enable the mobile wireless device to increase the balance of the merchant's prepayment account for the distributor by the requested amount where the wireless mobile device is able to display the balance of the merchant's prepayment account for the distributor, notifying the distributor that the balance of the merchant's prepayment account for the distributor has been increased by the requested amount so that the distributor can authorize an unscheduled delivery to the merchant, transmitting an over-the-air message including an encrypted version of the key to a reader device used by delivery personnel acting on behalf of the distributor so that the reader device can access the secure element of the mobile wireless device using offline near field communication to alter the balance of the merchant's prepayment account for the distributor, receiving a settlement over-the-air message from a reader device indicating an amount to be deleted from the balance of the merchant's prepayment account for the distributor that reflects the cost of merchandise delivered by delivery personnel on behalf of the distributor, where the distributor has decrypted the received encrypted key and accessed the secure element of the mobile wireless device to decrease the balance of the merchant's prepayment account for the distributor stored in the secure element by the cost of merchandise delivered.

### RELATED APPLICATIONS

This application claims priority from a provisional application entitled PREPAID DISTRIBUTION CARD, application No. 61/371,422, filed Aug. 06, 2010, which is hereby incorporated by reference for all purposes.

### TECHNICAL FIELD

The present disclosure relates generally to prepaid accounts and to the management of distributor-merchant financial transactions and relationships. In particular, it relates to methods for conducting a financial transaction using a Near Field Communication

(NFC) mobile device application issued by a program manager and for conducting an offline transactions with delivery presonnel in a secure and guaranteed manner.

### BACKGROUND OF THE INVENTION

In many cases merchants have a standing relationship with a distributor or supplier for delivery of a specified amount of merchandise at periodic intervals. A merchandise deliverer, for example a driver employed by the distributor or supplier, may make delivery of the merchandise after the expiration of each periodic interval. Typically, the merchant will have an account with the distributor or supplier and make payment to the account on a pre-arranged schedule. The deliverer is authorized by the distributor or supplier to make the delivery and is not required to receive payment in hand from the merchant.

For example, the merchant could be a restaurant that orders beverages from a beverage distributor or supplier. If the merchant takes inventory and realizes that it needs to increase its beverage inventory before the next scheduled shipment it may place a supplemental order for immediate delivery. There may not be funds in the merchant's account with the distributor or supplier to cover the unscheduled delivery. The driver may be required to collect cash or implement another payment procedure for which the driver may not be well prepared.

If the driver accepts payment in cash a security problem is created because the driver is in the field carrying an amount of cash. Of further concern is that without a method in place for conducting immediate unscheduled transactions with a merchant client, the distributor or supplier may lose the order to a competitor.

### BRIEF DESCRIPTION OF THE DRAWINGS

FIG. 1 is a block diagram that illustrates a system provided in accordance with the present invention.

FIG. 2 is a block diagram that illustrates an embodiment of a “back office” server computer that is part of the system of FIG. 1 and that may be provided in accordance with aspects of the present invention.

FIG. 3 is a block diagram that illustrates an embodiment of a “reload” server computer that is part of the system of FIG. 1 and that may be provided in accordance with aspects of the present invention.

FIG. 4 is a block diagram that illustrates a mobile wireless device that is used in connection with the system of FIG. 1 and that is provided in accordance with aspects of the present invention.

FIG. 5 is a block diagram that illustrates some details of the mobile wireless device of FIG. 4 and that is provided in accordance with aspects of the present invention.

FIG. 6 is a diagram that illustrates aspects of program instructions stored in the mobile telephone of FIG. 4 and that is provided in accordance with aspects of the present invention.

FIG. 7 is a block diagram that illustrates some details of the reader device of FIG. 1 and that is provided in accordance with aspects of the present invention.

FIG. 8 is a flow chart that illustrates a process that may be performed by a prepayment account enrollment server and that is provided in accordance with aspects of the present invention.

FIG. 9 is a block diagram that illustrates some details of the prepayment account enrollment server and that is provided in accordance with aspects of the present invention.

FIG. 10 is a flow chart that illustrates a process that may be performed by a prepayment account enrollment server in accordance with aspects of the present invention.

FIG. 11 is a flow chart that illustrates a process that may be performed in the top up server of FIG. 3 in accordance with aspects of the present invention.

FIG. 12 is a flow chart that illustrates a process that may be performed in the mobile wireless device of FIG. 4 in accordance with aspects of the present invention.

FIG. 13 is a flow chart that illustrates a process that may be performed in the reader device of FIG. 7 during a delivery in accordance with aspects of the present invention.

FIG. 14 is a flow chart that illustrates a process that may be performed in the reader device of FIG. 7 during settlement in accordance with aspects of the present invention.

FIG. 15 is a flow chart that illustrates a process that may be performed in the reader device of FIG. 7 during clearing of a transaction in accordance with aspects of the present invention.

### DETAILED DESCRIPTION OF EXAMPLE EMBODIMENTS

Reference will now be made in detail to various embodiments of the invention. Examples of these embodiments are illustrated in the accompanying drawings. While the invention will be described in conjunction with these embodiments, it will be understood that it is not intended to limit the invention to any embodiment. On the contrary, it is intended to cover alternatives, modifications, and equivalents as may be included within the spirit and scope of the invention as defined by the appended claims. In the following description, numerous specific details are set forth in order to provide a thorough understanding of the various embodiments. However, the present invention may be practiced without some or all of these specific details. In other instances, well known process operations have not been described in detail in order not to unnecessarily obscure the present invention. Further, each appearance of the phrase an “example embodiment” at various places in the specification does not necessarily refer to the same example embodiment.

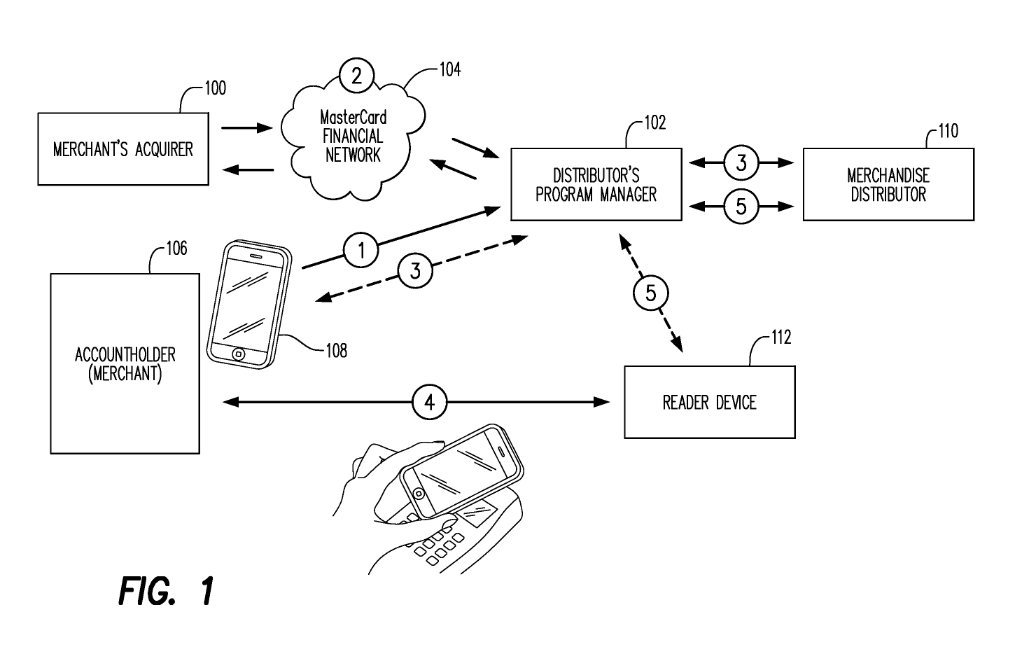

FIG. 1 is a block diagram of an example embodiment for enabling offline payments to delivery personnel delivering merchandise on behalf of a merchandise distributor or supplier. A Near Field Communication (NFC) mobile device is provided with an application which allows the merchant's prepayment account with the distributor or supplier to be reloaded with an amount sufficient to pay for an unscheduled delivery and provides capability for a cashless transaction between the deliverer and the merchant when the unscheduled delivery takes place.

FIG. 1 depicts a merchant acquirer computer 100 communicating with a distributor program manager computer 102 using the MasterCard Financial Network 104. An accountholder computer (merchant) 106 communicates with the program manager computer 102. Also depicted, by way of example, is an NFC-enabled mobile wireless device 108 that is an NFC-enabled smart phone which is used by the merchant in an off-line transaction with the deliverer. The program manager computer 102 also communicates with a merchandise distributor computer 110 and a wireless reader 112 used by the deliverer. FIG. 1 also depicts flows 1-5 which will be described in detail below.

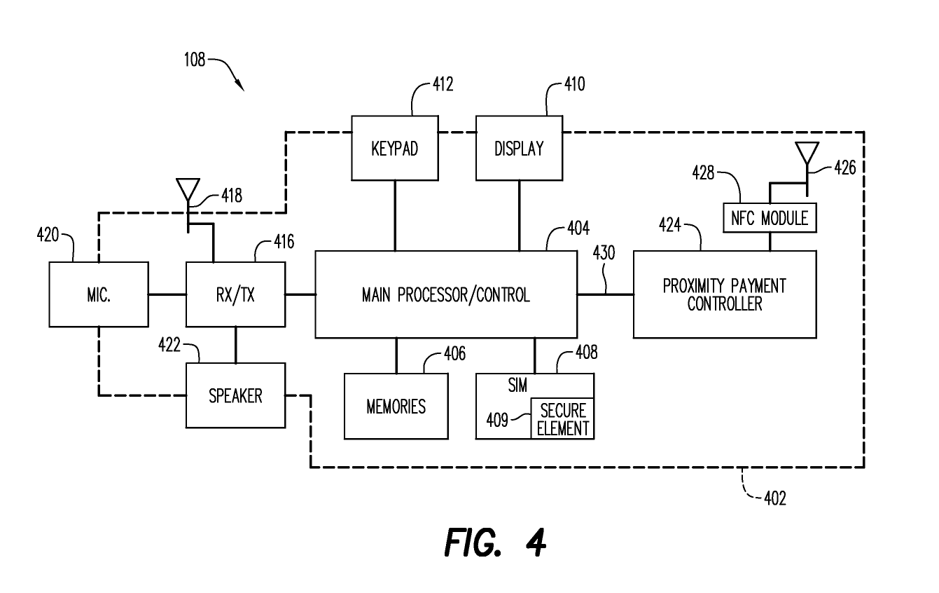

For purposes of illustration, only one mobile wireless device 108 and only one wireless reader device 112 are shown in FIG. 1. However, in practice, the system of FIG. 1 may encompass numerous mobile wireless NFC devices (belonging to numerous merchants) with prepaid payment capabilities, and may also include numerous wireless reader devices capable of handling offline purchase transactions by deducting stored value from such NFC-enabled wireless devices. (In addition, at least some of the wireless reader devices may be operative to handle offline purchase transactions with conventional prepaid cards as well as conventional online purchase transactions with contact, contactless, and/or magnetic stripe payment cards.) Details of the mobile wireless device 108 and wireless reader device 112 will be described below in conjunction with FIGS. 4-6.

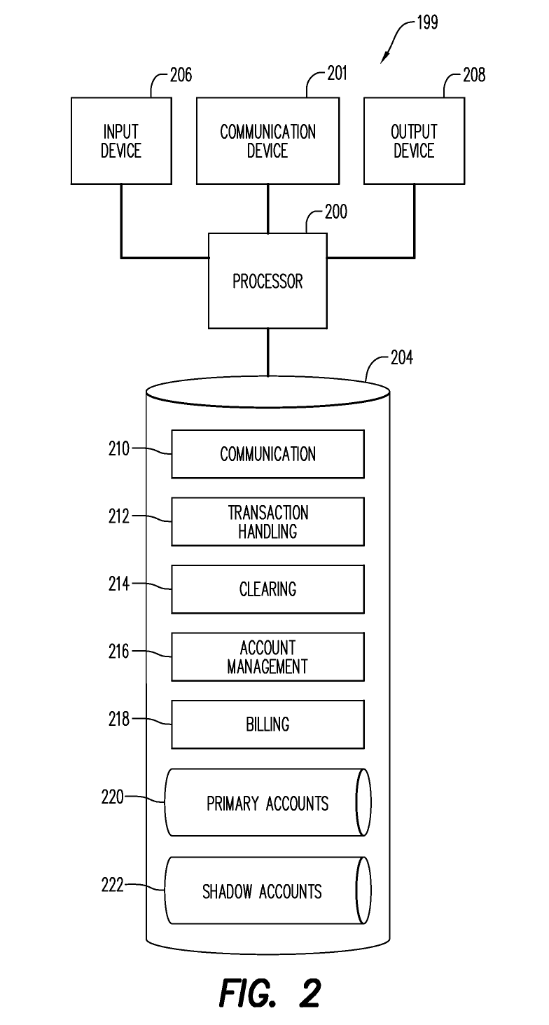

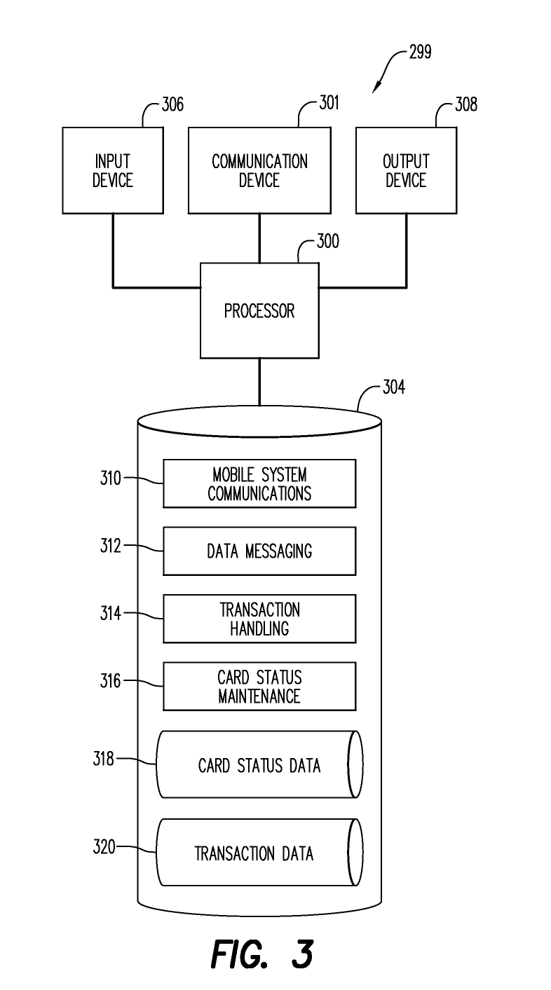

In the example embodiments the program manager computer 102 of FIG. 1 may be an entity that has access to an issuer back-office server computer and a reload authorization computer, both of which are described below. Accordingly, the program manager may be a separate entity that is affiliated with an issuer, may be operated by the distributor itself or may be controlled by the issuer. In this example embodiment the program manager includes both the issuer back-office server computer 199 of FIG. 2 and a reload authorization server computer 299 of FIG. 3.

Before describing some of the components of the system in more detail, an overview of operation of the system of FIG. 1 will now be provided.

After the merchant enrolls with the service the secure application is downloaded to the merchant's NFC-enabled wireless device 108 to establishe secure communications between the program manager and the downloaded secure application. In an example embodiment, the secure application includes programs to implement encryption and decryption of messages using the M/Chip Select 4 standard.

In order for the NFC-enabled wireless device 108 to engage in an offline purchase transaction, the NFC-enabled wireless device must first be loaded with a prepaid account balance. In this embodiment the program manager computer 102 includes, or has access to, a reload authorization server computer 299 and an issuer back-office server computer 199. This account balance loading is done via a reload transaction in which the NFC-enabled wireless device 108 and a reload authorization server 299 exchange Over-the-Air (OTA) encrypted messages. In the following, the term “over-the-air communications” includes all forms of wireless communications that uses energy (e.g. radio frequency (RF), infrared light, laser light, visible light, acoustic energy, etc.) to transfer information without the use of wires

In this example, the reload authorization server computer 299 communicates with the issuer back-office server computer 199 to determine whether the merchant's prepayment account is sufficiently funded, and if so the issuer back-office server computer 199 causes the amount of the reload to be charged to the merchant's prepayment account at the distributor using the MasterCard network 104. That amount is in turn transferred to a “shadow account” in the issuer back-office server computer 199 to be used for clearing the offline transaction originating from the merchant's NFC-enabled wireless device 108.

Upon receiving an indication from the issuer back-office server computer 199 that the reload may proceed, the reload authorization server computer 299 sends a response message to the NFC-enabled wireless device 108, causing the NFC-enabled wireless device 108 to increase the prepaid balance stored in the NFC-enabled wireless device 108 and displayed thereon.

Thereafter, the merchant and uses the NFC-enabled wireless device 108 to conduct an offline purchase transaction with the reader device to pay for an unscheduled delivery. The offline transaction may be performed via a NFC short-distance wireless exchange of messages between the reader device 112 and the NFC-enabled wireless device 108 using NFC ISO 18092. Other short-distance communication protocols such as ISO 14443 used by the financial industry for payments can also be utilized. For offline transactions, typically the merchant may be required to provide a PIN (personal identification number) as a form of authentication, but with no requirement for online communication with the program manager to obtain authorization for the transaction. By way of example, this exchange of messages may be conducted in accordance with the EMV or PayPass protocols for offline transactions.

The reader device 112 then communicates directly or indirectly with the program manager computer 102 to arrange for clearing of the transaction with the issuer back-office server computer 199 from the above-mentioned shadow account for the merchant, to result in crediting of the transaction amount to the distributor. In the clearing process, communication between the acquirer computer 100 and the issuer back-office server computer 199 may be carried out via a conventional payment system (not shown) such as that operated by the assignee hereof.

Details of the issuer back-office computer 199 are provided below in conjunction with FIG. 2. However, to briefly anticipate later discussion, the issuer back-office server computer may be operated by or on behalf of the financial institution (not separately shown) which issues the distributor prepayment account to the merchant. The issuer back-office server computer 199 handles and maintains records of payment and reload transactions engaged in by the NFC-enabled wireless device 108, and generally manages the merchant's activities in connection with its prepayment account.

Again, although only one issuer back-office server computer is shown in the drawing, in practice numerous issuers may participate in the system of FIG. 1, and accordingly there may be a considerable number of issuer back-office server computers included in the system. However, for a given merchant, all of its transactions will result in activity by the particular issuer back-office server computer operated by the issuer of the merchant's prepayment account with the distributor.

It should also be noted that the functions attributed in this document to the issuer back-office server computer may in some embodiments be distributed among two or more computers operating in conjunction with each other.

Details of the reload authorization server computer 299 will be provided below in conjunction with FIG. 3. Again to briefly anticipate later discussion, the reload authorization server computer 299 handles Over-The-Air (OTA) reload requests from NFC-enabled wireless devices, interacts with the issuer back-office server computer 199 to arrange for charging of the merchants' accounts, and issues OTA responses to the NFC-enabled wireless devices to implement reloads for the prepaid balances in the NFC-enabled wireless devices. While the OTA data may come from a network operator's network, it could also utilized the other communication channels available such as Wi-Fi, Bluetooth, RF, etc.

In some embodiments, there may be only one reload authorization server computer, which handles all reload requests for the system. However, in other embodiments, each issuer (and/or two or more groups of issuers) may set up its own reload authorization server computer 299 to handle reload requests for the merchants served by the issuer or issuers in question.

A merchant acquirer computer 100 is also shown in FIG. 1 as being part of the system of FIG. 1. The acquirer computer 100 may be operated by the financial institution with which the merchant does its banking. In practice, the acquirer computer 100 may also handle conventional online transactions that involve credit or debit cards accepted by the merchant.

There may be many financial institutions that participate in the system of FIG. 1 as acquirers. Consequently, the system of FIG. 1 may include many more acquirer computers than the single acquirer computer that is shown in the drawing.

The MasterCard financial network, depicted in the example embodiment of FIG. 1, validates account security features and coordinates exchange of information between the program manager and the acquirer.

FIG. 2 is a block diagram that illustrates an embodiment of the issuer back-office server computer 199.

The issuer back-office server computer 199 may be conventional in its hardware aspects but may be controlled by software to cause it to function as described herein. For example, the issuer back-office server computer 199 may be constituted by conventional server computer hardware.

The issuer back-office server computer 199 may include a computer processor 200 operatively coupled to a communication device 201, a storage device 204, an input device 206 and an output device 208.

The computer processor 200 may be constituted by one or more conventional processors. Processor 200 operates to execute processor-executable steps, contained in program instructions described below, so as to control the issuer back-office server computer 199 to provide desired functionality.

Communication device 201 may be used to facilitate communication with, for example, other devices (such as the reload authorization server computer 299 shown in FIG. 3). For example, communication device 201 may comprise numerous communication ports (not separately shown), to allow the issuer back-office server computer 199 to communicate simultaneously with a number of other computers, including for example computers that implement a payment system by which offline merchant transactions are cleared, and/or which handles conventional online payment card transactions.

Input device 206 may comprise one or more of any type of peripheral device typically used to input data into a computer. For example, the input device 206 may include a keyboard and a mouse. Output device 208 may comprise, for example, a display and/or a printer.

Storage device 204 may comprise any appropriate information storage device, including combinations of magnetic storage devices (e.g., magnetic tape and hard disk drives), optical storage devices such as CDs and/or DVDs, and/or semiconductor memory devices such as Random Access Memory (RAM) devices and Read Only Memory (ROM) devices, as well as so-called flash memory. Any one or more of such information storage devices may be considered to be a computer-readable storage medium or a computer usable medium or a memory.

Storage device 204 stores one or more programs for controlling processor 200. The programs comprise program instructions (which may be referred to as computer readable program code means) that contain processor-executable process steps of issuer back-office server computer 199, executed by the processor 200 to cause the issuer back-office server computer 199 to function as described herein.

The programs may include a communication application 210 that controls the processor 200 to enable the issuer back-office server computer 199 to engage in data communication with other computers in a conventional manner. The programs may also include a transaction handling application 212 that controls the processor 200 to enable the issuer back-office server computer 199 to handle prepayment account transactions in a conventional manner. Among these transactions may be charges to merchants' prepayment accounts in regard to reload transactions implemented by the reload authorization server computer 299 in cooperation with the issuer back-office server computer 199. The transaction handling application 212 may also handle conventional payment card system purchase transactions.

Another program that may be stored on the storage device 204 is a transaction clearing application 214. The clearing application 214 may enable the issuer back-office server computer 199 to respond to clearing requests originating from acquirer computers (e.g., via a payment system which is not shown) to clear offline transactions engaged in by the issuer's customers. The clearing application 214 may function to clear the offline transactions against the merchants' shadow accounts.

In this example embodiment, the transaction clearing application 214 also allows the back-office server computer 199 to respond to clearing requests originating from the program manager in response to offline transactions between the merchant and the deliverer.

The programs stored on the storage device 204 may further include an account management application 216. The application may manage merchants' payment and shadow accounts, including opening and closing of accounts, and overseeing whether the accounts are maintained in good standing (e.g., by merchants' timely payment of amounts due).

Still further, the programs stored on the storage device 204 may include a billing application 218. The billing application 218 may handle generation of bills to merchants and may track whether payments are received as required.

The storage device 204 may also store data required for operation of the issuer back-office server computer 199, including data 220 regarding merchants' prepayment account balances and transactions, and data 222 relating to merchants' shadow accounts that are used to clear offline transactions.

FIG. 3 is a block diagram that illustrates an embodiment of the reload authorization server computer 299.

The reload authorization server computer 299 may be conventional in its hardware aspects but may be controlled by software to cause it to function as described herein and in accordance with aspects of the present invention. For example, the reload authorization server computer 299 may be constituted by conventional server computer hardware.

The reload authorization server computer 299 may include a computer processor 300 operatively coupled to a communication device 301, a storage device 304, an input device 306 and an output device 308.

The computer processor 300 may be constituted by one or more conventional processors. Processor 300 operates to execute processor-executable steps, contained in program instructions described below, so as to control the reload authorization server computer 299 to provide desired functionality.

Communication device 301 may be used to facilitate communication with, for example, other devices (such as the issuer back-office server computer 199 shown in

FIG. 2 and NFC-enabled mobile device 108 shown in FIG. 1). For example, communication device 301 may include one or more interfaces (not separately shown) by which the reload authorization server computer 299 may engage in OTA communications with merchants' NFC-enabled wireless devices. For example, communication device 301 may comprise numerous communication ports (not separately shown).

Input device 306 may comprise one or more of any type of peripheral device typically used to input data into a computer. For example, the input device 306 may include a keyboard and a mouse. Output device 308 may comprise, for example, a display and/or a printer.

Storage device 304 may comprise any appropriate information storage device, including combinations of magnetic storage devices (e.g., magnetic tape and hard disk drives), optical storage devices such as CDs and/or DVDs, and/or semiconductor memory devices such as Random Access Memory (RAM) devices and Read Only Memory (ROM) devices, as well as so-called flash memory. Any one or more of such information storage devices may be considered to be a computer-readable storage medium or a computer usable medium or a memory.

Storage device 304 stores one or more programs for controlling processor 300. The programs comprise program instructions (which may be referred to as computer readable program code means) that contain processor-executable process steps of reload authorization server computer, executed by the processor 300 to cause the reload authorization server computer 299 to function as described herein and in accordance with aspects of the present invention.

The programs may include an application 310 that controls the processor 300 to enable the reload authorization server computer 299 to engage in OTA communications with merchants' NFC-enabled wireless devices. For example, the application 310 may enable the reload authorization server computer 299 to engage in data communication with NFC-enabled wireless devices via GPRS (General Packet Radio Service). The communications between the NFC-enabled wireless devices and the reload authorization server computer 299 may be in the nature of webpage access sessions.

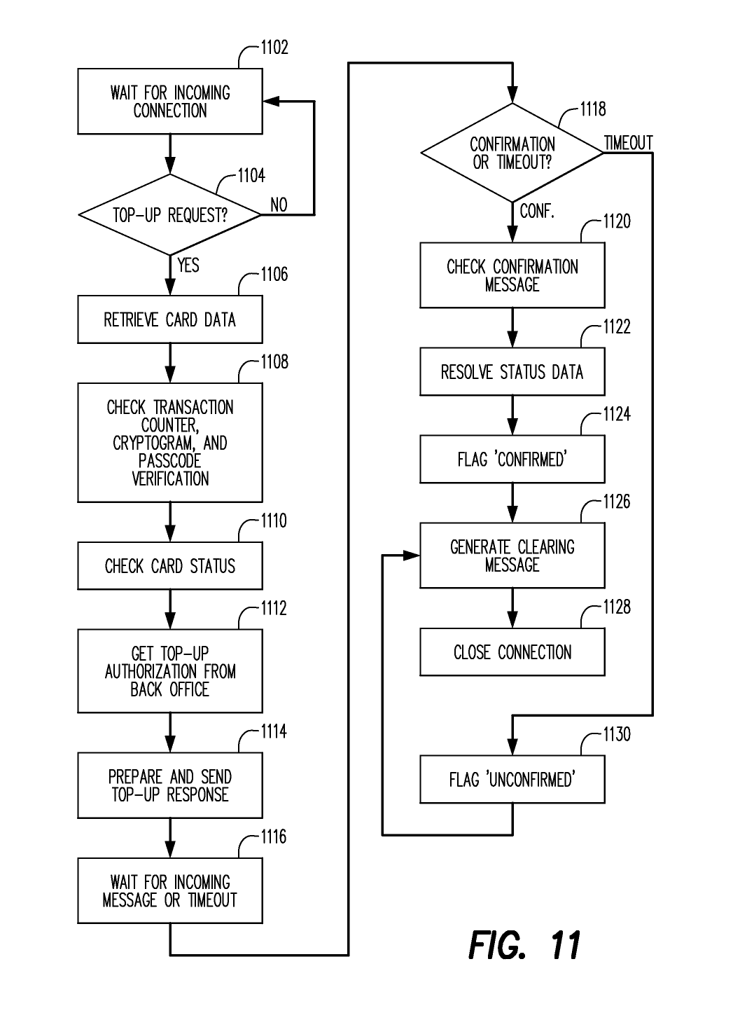

The programs stored in the storage device 304 may also include conventional data communication software 312 with which the reload authorization server computer 299 may exchange data messages with other computers, such as the issuer back-office server computer 199. The programs may also include a transaction handling application 314 that controls the processor 300 to enable the reload authorization server computer 299 to handle reload transactions, as described in more detail below in connection with FIG. 11.

Another program that may be stored on the storage device 304 is an application 316 that controls processor 300 such that the reload authorization server computer 299 maintains a database (reference numeral 318; also stored on the storage device 304) relating to the status of merchants' accounts. For example, the status information may indicate balance parameters for the merchants' accounts, and one or more flags that aid the reload authorization server computer 299 in determining whether the latest reload transaction was confirmed as having been successfully completed. The status information may also include a transaction counter value. The status information may, for example, be indexed by the merchant's primary account number (PAN).

The storage device 304 may also store a database 320 which stores information regarding the reload transactions handled by the reload authorization server computer 299.

FIG. 4 is a block diagram of an example NFC-enabled smart phone, which is an example of the NFC-enabled mobile wireless device 108 depicted in FIG. 1. The NFC-enabled wireless device 108 may be conventional in its hardware aspects.

The NFC-enabled wireless device 108 may include a conventional housing (indicated by dashed line 402 in FIG. 4) that contains and/or supports the other components of the NFC-enabled wireless device 108. The housing 402 may be shaped and sized to be held in a merchant's hand, and may for example fit in the palm of the merchant's hand.

The NFC-enabled wireless device 108 further includes conventional control circuitry 404, for controlling overall operation of the NFC-enabled wireless device 108. Other components of the NFC-enabled wireless device 108, which are in communication with and/or controlled by the control circuitry 404, include: (a) one or more memory devices 406 (e.g., program and working memory); (b) a SIM (subscriber identification module) card 408 which in this example includes a Secure Element 409; (c) a keypad 412 for receiving merchant input; and (d) a conventional display component 410 for displaying output information to the merchant. For present purposes the keypad 412 will be understood to include, for example, a conventional 12-key telephone keypad, in addition to other buttons, switches and keys, such as a conventional rocker-switch/select key combination, soft keys, and send and end keys and can also include a touch-screen pad utilized on smart phones.

In this example embodiment, the secure application downloaded from the program manager may be stored in the one or more memory devices 406.

The NFC-enabled wireless device 108 also includes conventional receive/transmit circuitry 416 that is also in communication with and/or controlled by the control circuitry 404. The receive/transmit circuitry 416 is coupled to an antenna 418 and provides the communication channel(s) by which the NFC-enabled wireless device 108 communicates via the NFC-enabled wireless device communication network (not shown). The receive/transmit circuitry 416 may operate both to receive and transmit voice signals, in addition to performing data communication functions, such as GPRS, Wi-Fi, Bluetooth, Contactless and Infrared communications.

The NFC-enabled wireless device 108 further includes a conventional microphone 420, coupled to the receive/transmit circuitry 416. Of course, the microphone 420 is for receiving voice input from the merchant. In addition, a loudspeaker 422 is included to provide sound output to the merchant, and is coupled to the receive/transmit circuitry 416.

In conventional fashion, the receive/transmit circuitry 416 operates to transmit, via the antenna 418, voice signals generated by the microphone 420, and operates to reproduce, via the loudspeaker 422, voice signals received via the antenna 418. The receive/transmit circuitry 416 may also handle transmission and reception of text messages and other data communications via the antenna 418.

The NFC-enabled wireless device 108 also includes a Near Field

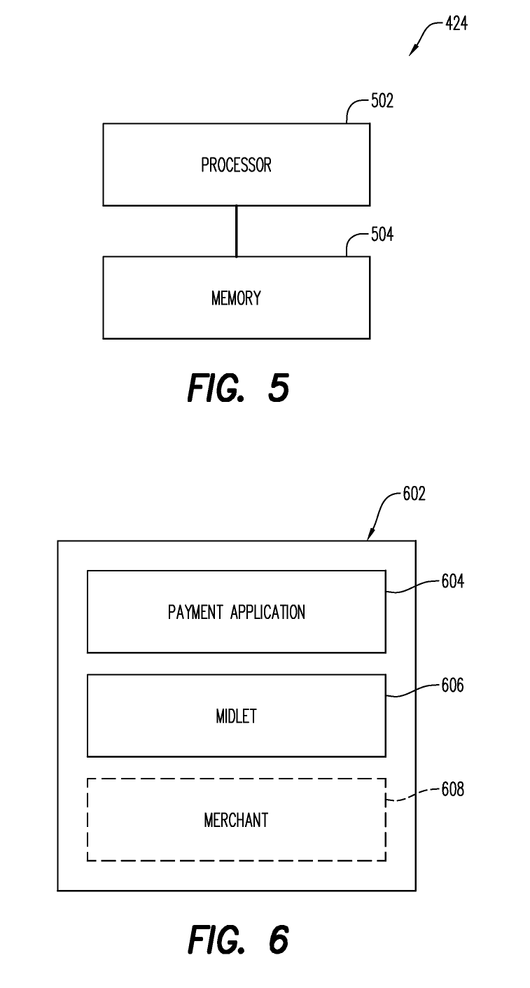

Communication (NFC) module 428 which allows near-field (approximately 4 cm) communication with other NFC-enabled devices to make payment transactions and exchange other types of information. The NFC module 428 can either be built into the mobile device or an attachment to an existing mobile device. The NFC module is in communication with the Secure Element 409 of the SIM card 408. Details of the payment circuit 424 are shown in block diagram form in FIG. 5.

Referring then to FIG. 5, the payment circuit 424 includes a processor 502. Although shown as separate from the main processor 404 (FIG. 4), the processor 502 may be integrated with the main processor. If separate from the main processor 404, the processor 502 may be in communication therewith (as suggested by connection 430 shown in FIG. 4). In addition or alternatively, the processor 502 may be at least partially provided on the SIM card 408.

Continuing to refer to FIG. 5, the payment circuit 424 further includes a memory 504 that is in communication with the processor 502. The memory 504 may be constituted by one or more different devices that store data and/or program instructions, and may overlap at least partially with the memories 406 shown in FIG. 4. (Alternatively, the memory 504 may be separate from the memories 406 shown in FIG. 4.) The memory 504 may store program instructions (which may also be referred to as computer readable program code means) that control the operation of the processor 502 to provide functionality as described herein. The memory 504 may also be referred to as a computer readable medium.

FIG. 6 schematically illustrates aspects of at least some of the program instructions (generally indicated by reference numeral 602) stored in the memory 504 shown in FIG. 5. In this example, the program instructions 602 are part of the secure application downloaded from the program manager. For example, the program instructions 602 may include a payment application 604. The payment application 604 may operate in a substantially conventional manner to implement some aspects of offline payment functionality in the NFC-enabled wireless device 108. For example, in some embodiments, the payment application 604 may be, or may be similar to, the M/Chip 4 Select program that has been made publicly available by the assignee hereof. In some embodiments, a major function of the payment application 604 may be to store the available balance for offline purchase transactions. In some embodiments, the available balance may be effectively stored in terms of two amounts, namely an upper cumulative transaction amount, and an actual cumulative transaction amount, with the available balance being the difference between the two amounts. Consequently, in these embodiments, reloading may be executed by increasing the upper cumulative transaction amount.

In an example embodiment, a major function of the payment application 604 is to display the available balance on the display 410 of the NFC-enabled wireless device 108.

The program instructions 602 include a “midlet” 606. The midlet 606 is an application program that may operate as “middleware” to manage interactions among the payment application 604, the merchant and the reload authorization server computer. In other words, the midlet 606 may provide a software interface among the payment application 604, merchant interface software 608 (shown in phantom in FIG. 6; in practice the merchant interface software may be stored in the one or more of the main memories 406, FIG. 4), and the reload authorization server computer. Details of operation of the midlet 606 will be described below in connection with FIG. 12.

In some embodiments a “personalization” or “authentication” process may be performed with respect to the NFC-enabled wireless device 108 to enable it to perform as a prepaid payment device. The personalization process may include loading the payment application, the midlet, and account- and/or merchant-specific data (e.g., PAN, merchant name) into one or more memories in the NFC-enabled wireless device 108. The personalization process may generally be performed in a conventional manner. An example personalization process is described in commonly-assigned U.S. patent application Ser. No. 11/958,695, filed Dec. 18, 2007.

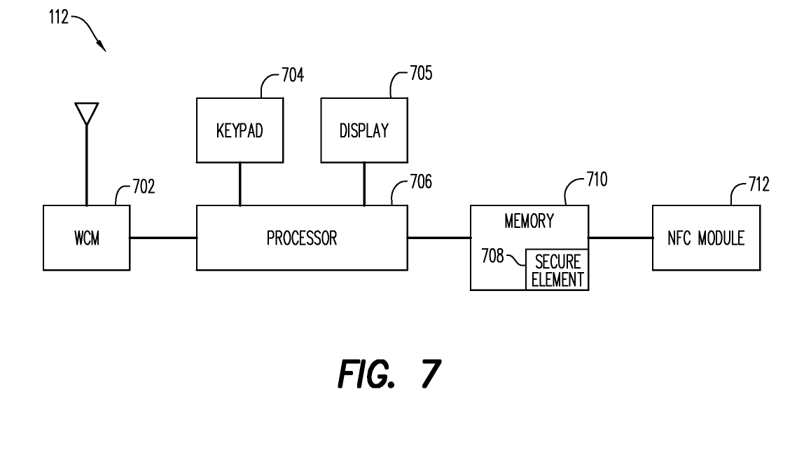

A block diagram of the deliverer's reader device is depicted in FIG. 7. The device in this example embodiment includes a least a wireless communication module 702, a keypad 704, a display 705, a processor 706, a Secure Element 708, a memory 710 for holding data and program code and an NFC module 712.

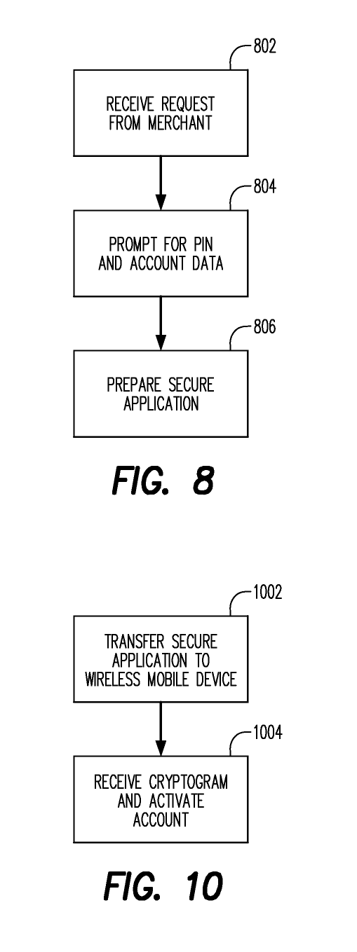

The various flows depicted in FIG. 1 will now be described with reference to FIGS. 8-15.

In flow 1, as depicted in the flow chart of FIG. 8, the merchant enrolls to participate in the distributor's prepayment account program. In this example, the prepayment account is a branded account that is affiliated with a particular distributor thereby offering opportunities to create loyalty to the distributor. The account is managed on behalf of the distributor by a program manager engaged by the distributor. One example of a program manager is MasterCard Repower operated by the assignee of the present application.

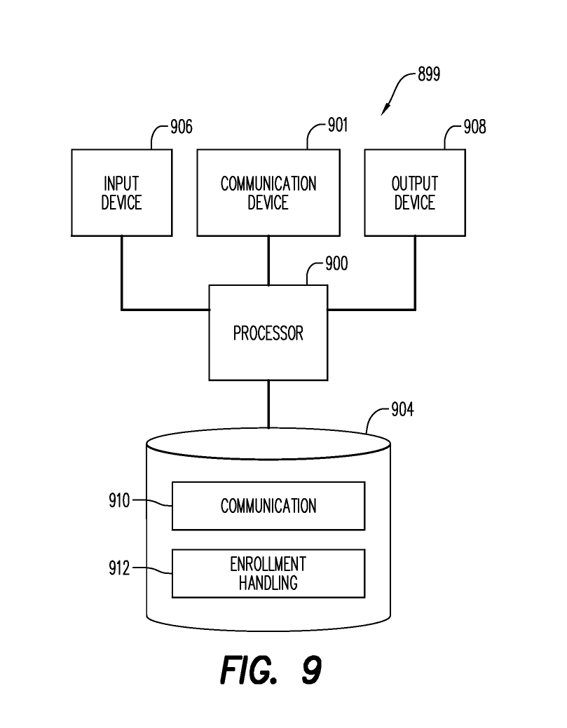

Referring to FIG. 8, in step 802 an enrollment server (899 depicted below in FIG. 9) receives a request from a merchant to enroll in a prepayment account for the distributor.

The merchant may request to enroll and communicate with the enrollment server using a web browser on the merchant computer or NFC-enabled mobile device or interactive voice response (ivr) features of the NFC-enabled mobile device.

The process moves to step 804. In step 804 the enrollment server prompts the enrolling merchant for information required to set up a prepayment account, such as the merchant's acquirer, personal data and a PIN.

The process then moves to step 806. In step 806 the enrollment server prepares a secure application to be downloaded to the enrolling merchant.

In this example, the program manager computer 102 includes, or has access to, a prepayment account enrollment server 899 which is depicted in FIG. 9.

Referring to FIG. 9, the prepayment account enrollment server 899 may be conventional in its hardware aspects but may be controlled by software to cause it to function as described herein. For example, the prepayment account enrollment server 899 may be constituted by conventional server computer hardware.

The prepayment account enrollment server 899 may include a computer processor 900 operatively coupled to a communication device 901, a storage device 904, an input device 906 and an output device 908.

The computer processor 900 may be constituted by one or more conventional processors. Processor 900 operates to execute processor-executable steps, contained in program instructions described below, so as to control the prepayment account enrollment server 899 to provide desired functionality.

Communication device 901 may be used to facilitate communication with, for example, other devices (such as the NFC-enabled wireless device in FIG. 1 and the issuer back-office and reload servers depicted in FIGS. 2 and 3). For example, communication device 901 may comprise numerous communication ports (not separately shown) to allow the prepayment account enrollment server 899 to communicate simultaneously with a number of other computers, including for example computers that implement a payment system by which offline merchant transactions are cleared, and/or which handle conventional online payment card transactions.

Input device 906 may comprise one or more of any type of peripheral device typically used to input data into a computer. For example, the input device 906 may include a keypad and a mouse. Output device 908 may comprise, for example, a display and/or a printer.

Storage device 904 may comprise any appropriate information storage device, including combinations of magnetic storage devices (e.g., magnetic tape and hard disk drives), optical storage devices such as CDs and/or DVDs, and/or semiconductor memory devices such as Random Access Memory (RAM) devices and Read Only Memory (ROM) devices, as well as so-called flash memory. Any one or more of such information storage devices may be considered to be a computer-readable storage medium or a computer usable medium or a memory.

Storage device 904 stores one or more programs for controlling processor 900. The programs comprise program instructions (which may be referred to as computer readable program code means) that contain processor-executable process steps of issuer back-office server computer 199, executed by the processor 900 to cause the prepayment account enrollment server 899 to function as described herein.

The programs may include a communication application 910 that controls the processor 900 to enable the prepayment account enrollment server 899 to engage in data communication with other computers in a conventional manner. The programs may also include an enrollment handling application 912 that controls the processor 900 to enable the prepayment account enrollment server 899 to receive enrollment requests, prompt an enrollee for required information, prepare a secure application and transfer the secure application to the enrollee.

The process of flow 2 is depicted in the flow chart of FIG. 10.

In step 1002 the enrollment server 899 transfers a secure application to the NFC-enabled mobile device.

In step 1004 the enrollment server receives authentication information, e.g., in the form of a cryptogram, and activates the merchant's prepayment account.

The merchant then requests a monetary reload to its distributor's prepayment account.

In flow 3, as depicted in FIGS. 11-12, the merchant's prepayment account is reloaded with a requested amount of money. The process steps performed at the reload server are described with reference to FIG. 11 and the process steps performed by the NFC-enabled wireless device are described with reference to FIG. 12.

FIG. 11 is a flow chart that illustrates a process that may be performed in the reload authorization server computer 299 in accordance with aspects of the present invention.

At 1102 in FIG. 11, the reload authorization server computer 299 waits until an incoming connection occurs. That is, the reload authorization server computer 299 awaits receiving an OTA communication from a merchant's NFC-enabled wireless device (represented by the NFC-enabled wireless device 108 in FIG. 1). Continuing to refer to FIG. 11, at 1104 the reload authorization server computer 299 determines whether it has received a request (in the form of an OTA message) for a reload transaction from the NFC-enabled wireless device 108 via the OTA connection. If not, the process of FIG. 10 may loop back to 1102. However, if it is determined at 1104 that a reload request has been received, then the process of FIG. 11 advances from 1104 to 1106.

At 1106, the reload authorization server computer 299 retrieves from database 318 (FIG. 3) data related to the merchant's prepayment account number, as contained in the reload request. The retrieved data may include status information to aid the reload authorization server computer 299 in determining whether the most recent previous reload transaction was confirmed as having been successfully completed. In addition, the retrieved data may include information relating to the most recent known and/or pending available balance for the NFC-enabled wireless device 108. For example, the balance information may be a cumulative upper limit to offline transactions that was previously loaded or attempted to be loaded into the NFC-enabled wireless device 108.

The process of FIG. 11 advances from 1106 to 1108. At 108 the reload authorization server computer 299 performs checks with respect to information contained in the reload request received from the NFC-enabled wireless device 108. For example, the reload request may include a cryptogram, and the reload authorization server computer 299 may perform a cryptographic calculation to produce a result that should match the received cryptogram if the received cryptogram is valid. The reload request may also include an indication as to whether the merchant properly entered a passcode in the process of generating the reload request with the NFC-enabled wireless device, and the reload authorization server computer 299 may check to see that the indication has the proper value. Further, the reload request may include a transaction counter value, and the reload authorization server computer 299 may determine whether the transaction counter value in the reload request matches the expected value indicated by the prepayment account data received at 1106.

Following step 1108 is step 1110. At 1110, the reload authorization server computer 299 may determine, from the retrieved payment account data, whether the most recent previous reload transaction was confirmed to have been properly completed. If the payment account data indicates that this was not the case, the reload authorization server computer 299 may use data included in the reload request to synchronize the payment account data (from database 318, FIG. 3) with prepaid balance information contained in the reload request. That is, the reload authorization server computer 299 may determine from information contained in the reload request whether the most recent previous reload transaction was completed successfully, and then may resolve the cumulative upper limit for prepaid transactions for the NFC-enabled wireless device in question to reflect such information as contained in the reload request received from the NFC-enabled wireless device 108.

Step 1112 then follows step 1110. At 1112, the reload authorization server computer 299 communicates with the issuer back-office server computer 199 to determine whether the reload request should be authorized. In essence, the reload authorization server computer 299 inquires of the issuer back-office server computer 199 whether the merchant's underlying payment account will support the requested reload, and receives a response back from the issuer back-office server computer 199 to indicate whether or not this is the case. If the issuer back-office server computer 199 provides a positive response, then the reload authorization server computer 299 charges the requested reload to the merchant's account, and the process of FIG. 11, as performed in the reload authorization server computer, advances to 1114 from 1112. (In a branch of the process which is not explicitly shown in the drawing, if the issuer back-office server computer 199 provides a negative response, then the reload authorization server computer 299 sends a message back to the NFC-enabled wireless device 108 to indicate that the reload request is declined.)

In this example, all communications between the reload authorization server computer 299 and the secure element 409 of the NFC-enabled wireless device 108 of

FIG. 4 are encrypted using, for example, the encryption techniques defined in the M/Chip Select 4 standard.

At 1114, the reload authorization server computer 299 updates the payment account data (for database 318) to reflect authorization of the reload request. The reload authorization server computer 299 also calculates new balance information to implement the reload request. For example, the reload authorization server computer 299 may add the requested amount of the reload to the previous upper cumulative transaction amount to produce a new upper cumulative transaction amount. This amount may be stored in the payment account data, and also may be used to generate the response that the reload authorization server computer 299 is to send to the NFC-enabled wireless device 108. For example, the reload authorization server computer 299 may generate a script that is to be executed by the NFC-enabled wireless device to increase the upper cumulative transaction amount stored in the NFC-enabled wireless device. In addition, the reload authorization server computer 299 may generate a cryptogram to be included in the response. This may be done, for example, in accordance with the provisions of the above-mentioned M/Chip Select 4 standard. The reload authorization server computer 299 may then send a response, including the script and the cryptogram, to the NFC-enabled wireless device 108 as the response to the reload request.

Following 1114, the process of FIG. 11 advances to 1116. At 1116, the reload authorization server computer 299 waits for a confirmation message from the NFC-enabled wireless device (to confirm that the reload transaction was successfully completed in the NFC-enabled wireless device 108) or for a timeout period to elapse. At decision block 1118, the reload authorization server computer 299 determines which of these two conditions takes place. If, at 1118, the reload authorization server computer 299 determines that it has received a confirmation message from the NFC-enabled wireless device 108, then the process advances from decision block 1118 to block 1120.

At 1120, the reload authorization server computer 299 performs validity checks with respect to the confirmation message received from the NFC-enabled wireless device 108. For example, the reload authorization server computer 299 may check that a transaction counter in the confirmation message has an expected value, and that a cryptogram included in the confirmation message is valid. The reload authorization server computer 299 may also check the correctness of balance information (e.g., an upper cumulative transaction amount) included in the confirmation message.

Step 1122 follows step 1120. At 1122 the reload authorization server computer 299 updates the payment account data (status data) to reflect the confirmation that the reload transaction was successfully completed at the NFC-enabled wireless device 108. This may involve, for example, resolving the balance information to reflect successful completion of the reload transaction. One or more status flags may also be set to appropriate values. In addition, as indicated at 1124, the reload authorization server computer 299 may set the appropriate flag to indicate that the just authorized reload was “confirmed”. The reload authorization server computer 299 may next, as indicated at 1126, generate a clearing record (including the “confirmed” flag), and then close the OTA messaging connection, as indicated at 1128. (Although not so indicated in the drawing, the process may then loop back from 1128 to 1102, to await another incoming connection.) Considering again decision block 1118, if it is the case that the timeout period expires prior to receipt of a confirmation message, then the process branches from 1118 to 1130. At 1130, the reload authorization server computer 299 sets a flag to indicate an “unconfirmed” status for the request reload transaction. The process then advances from 1130 to 1126, at which the reload authorization server computer 299 generates a clearing record including the “unconfirmed” flag that indicates the ambiguous status of the just authorized reload. The “unconfirmed” flag serves as an indication that the ambiguity needs to be resolved upon receipt of the next reload request from the NFC-enabled wireless device in question. The process of FIG. 11 then advances from 1126 to 1128, as described above.

FIG. 12 is a flow chart that illustrates an example process that may be performed in the NFC-enabled wireless device 108 of FIG. 4 during a load or reload transaction.

At 1202 in FIG. 12, the NFC-enabled wireless device 108 (e.g., via the midlet 606, FIG. 6) determines whether the merchant has indicated that he/she wishes to request a reload for the NFC-enabled wireless device's prepaid payment capability. For example, the midlet may receive an indication to this effect as a result of the merchant providing input to the NFC-enabled wireless device by selecting an item in a menu presented by the merchant interface 608 (FIG. 6) provided by the NFC-enabled wireless device 108. Such a menu, for example, may be presented by a “wallet” function that the merchant has accessed in the NFC-enabled wireless device 108.

As indicated by branch 1204 from 1202, the process of FIG. 12 may idle at 1202 until the merchant indicates that a reload should be requested. However, once the NFC-enabled wireless device 108 receives such an indication, then the process of FIG. 12 advances from 1202 to 1206.

At 1206, the NFC-enabled wireless device (e.g., via midlet 606) opens an OTA messaging connection (e.g., a GPRS connection) with the reload authorization server computer 299. In connection with this step, for example, the midlet 606 may retrieve the “http” address of the reload authorization server computer.

Then, at 1208, the NFC-enabled wireless device (e.g., via midlet 606 and merchant interface 608) prompts the merchant to enter a monetary amount by which the prepaid balance is to be reloaded. This may be done, for example, by displaying one or more messages on the display 410 (FIG. 4) of the NFC-enabled wireless device. For example, the merchant may be prompted to select a menu item, and/or to enter numerical data via the keypad 412 or by operating another input device included in the NFC-enabled wireless device.

In some embodiments, step 1206 may also include the midlet 606 querying the payment application 604 (FIG. 6) as to the current balance available in the NFC-enabled wireless device for prepaid transactions. The midlet 606 may then direct the merchant interface 608 to present this information to the merchant, while also asking the merchant to select/input a monetary amount for the reload request. In this example embodiment the midlet 606 is included in the secure application downloaded from the program manager.

Step 1210 follows step 1208. At step 1210, the NFC-enabled wireless device 108 receives, from the merchant, input to designate the monetary amount for the reload request. This may occur via the merchant interacting with the merchant interface 608, which passes the merchant's input to the midlet 606.

Step 1210 is followed by step 1212. At step 1212 the NFC-enabled wireless device 108 prompts the merchant to enter its passcode. This may occur via the midlet and the merchant interface, and is a security measure to reduce the possibility of unauthorized use of the NFC-enabled wireless device for payment purposes. More specifically, the merchant may enter the passcode by operating the keypad 412 or another input device included in the NFC-enabled wireless device. At step 1214, the NFC-enabled wireless device receives the merchant's input of the passcode, and at 1216 the NFC-enabled wireless device verifies the correctness of the passcode entered by the merchant. Both of these steps may entail cooperation among the payment application, the midlet, and the merchant interface.

In some embodiments, the payment application may limit the number of times the merchant may attempt to enter the passcode correctly. For example, the payment application may store a “passcode try counter” (PTC), which may be initially set at “3” and which may be decremented with each incorrect attempt to enter the passcode. If the PTC is at “0”, then the midlet may abort the merchant's attempt to request a reload. The payment application, the midlet, and the merchant interface may cooperate in permitting, tracking and limiting the number of times the merchant is allowed to attempt entry of the passcode.

Although the above steps 1206-1216 have been presented in the drawing and discussed above in a certain order, it should be understood that this order may be varied. For example, in some embodiments, the connection to the reload authorization server computer 299 may be opened only after the monetary amount for the reload has been entered and the passcode has been entered and verified. Similarly, in some embodiments, the passcode may be entered and verified before the monetary amount for the reload is entered.

Following steps 1206-1216 is step 1218. At 1218, the NFC-enabled wireless device 108 sends an OTA message to the reload authorization server computer 299 to request the reload desired by the merchant. This message may, for example, include a cryptogram that the NFC-enabled wireless device/payment application calculated before sending the message. The cryptogram may be passed from the payment application to the midlet for inclusion in the reload request. The message as constructed by the midlet may also include the monetary amount for the reload as specified by the merchant.

All communications between the reload authorization server 299 and the secure element 409 are encrypted using, for example, the encryption techniques defined in the M/Chip Select 4 standard.

Decision block 1220 follows step 1218. At 1220, the NFC-enabled wireless device determines whether it has received an OTA response to the reload request from the reload authorization server computer. As indicated by branch 1222 from decision block 1220, the process of FIG. 12 may idle until the response from the reload authorization server computer 299 is received. (In some embodiments, the process of FIG. 12 may time out and aborts if the response is not received within a predetermined period of time after the reload request is sent.)

When the OTA response from the reload authorization server computer 299 is received, the process of FIG. 12 advances from decision block 1220 to block 1224. (The ensuing description assumes that the response from the reload authorization server computer 299 indicates that the reload was authorized. If such is not the case, then the process of FIG. 12 may abort upon receiving the response from the reload authorization server computer.) At 1224, the midlet parses the response and passes the script contained in the response to the payment application. The payment application executes the script, thereby effecting an increase in the prepaid balance stored in secure element 409 of the NFC-enabled wireless device 108. For example, execution of the script may increase the upper cumulative transaction amount stored in the payment application.

The process of FIG. 12 advances from 1224 to 1225. The prepaid balance stored in the secure element is displayed.

The process of FIG. 12 advances from 1225 to 1226. At 1226, the midlet requests the upper cumulative transaction amount from the payment application to confirm that the reload was successfully completed by the payment application. The midlet also requests a script counter from the payment application. The script counter is for indicating to the reload authorization server computer 299 that the script sent in the response was executed by the payment application. Still further, the midlet may request the payment application to generate a cryptogram. The midlet then handles transmission of the confirmation message (as an OTA message) to the reload authorization server computer. The confirmation message may include the script counter and the cryptogram passed from the payment application to the midlet. After sending the confirmation message, the midlet may close the OTA connection to the reload authorization server computer, as indicated at 1228 in FIG. 12.

In some embodiments, the NFC-enabled wireless device 108 and the reload authorization server computer 299 may engage in OTA communication for purposes other than authorizing a reload request. For example, the NFC-enabled wireless device may communicate OTA with the reload authorization server computer 299 for the purpose of requesting a reset of the passcode try counter (PTC). From the point of view of the NFC-enabled wireless device, this process may be initiated in response to merchant input, and may entail the midlet opening an OTA connection with the reload authorization server computer. The midlet may request that the payment application generate a cryptogram, and may include the cryptogram in the PTC reset request message that the midlet sends OTA to the reload authorization server computer. In some embodiments, the PTC reset request message may also include the current upper cumulative transaction amount so that, if necessary, the reload authorization server computer 299 may confirm that the latest reload transaction was completed successfully in the NFC-enabled wireless device. After sending the PTC reset request message, the midlet may wait for a response from the reload authorization server computer.

Typically, the merchant may initiate the PTC reset request after making contact by voice telephone conversation with a customer service representative of the issuer. The merchant may, for example, tell the customer service representative that he/she needs a PTC reset, and may authenticate its identity by correctly answering one or more security questions posed to him/her by the customer service representative. The customer service representative would then provide input to the issuer back-office server computer 199 to indicate that a PTC reset is permitted. The issuer back-office server computer 199, in turn, may transmit a message to the reload authorization server computer 299 to indicate that a PTC reset is permitted. In response to that message, the reload authorization server computer 299 may set an appropriate flag in the payment account data for the merchant.

From the point of view of the reload authorization server computer, the PTC reset process itself begins with an incoming OTA connection from the NFC-enabled wireless device in question. The reload authorization server computer 299 receives the PTC reset request OTA from the NFC-enabled wireless device, retrieves the payment account data for the NFC-enabled wireless device, checks whether the PTC reset flag has been set, and performs checks on the request (e.g., checks a transaction counter and a cryptogram included in the request). If necessary, the reload authorization server computer 299 also resolves available balance information, as contained in the request, to confirm that the most recent reload was completed successfully.

If the request message checks out and the PTC reset flag in the retrieved payment account data is set, then the reload authorization server computer 299 generates and sends a suitable response to the NFC-enabled wireless device. The response is sent as an OTA message and may include a script to be executed in the NFC-enabled wireless device to effect a reset of the PTC.

When the NFC-enabled wireless device receives the response from the reload authorization server computer, the midlet parses the response and passes the script to the payment application. The payment application executes the script, thereby causing a reset of the PTC. The midlet then closes the OTA connection with the reload authorization server computer.

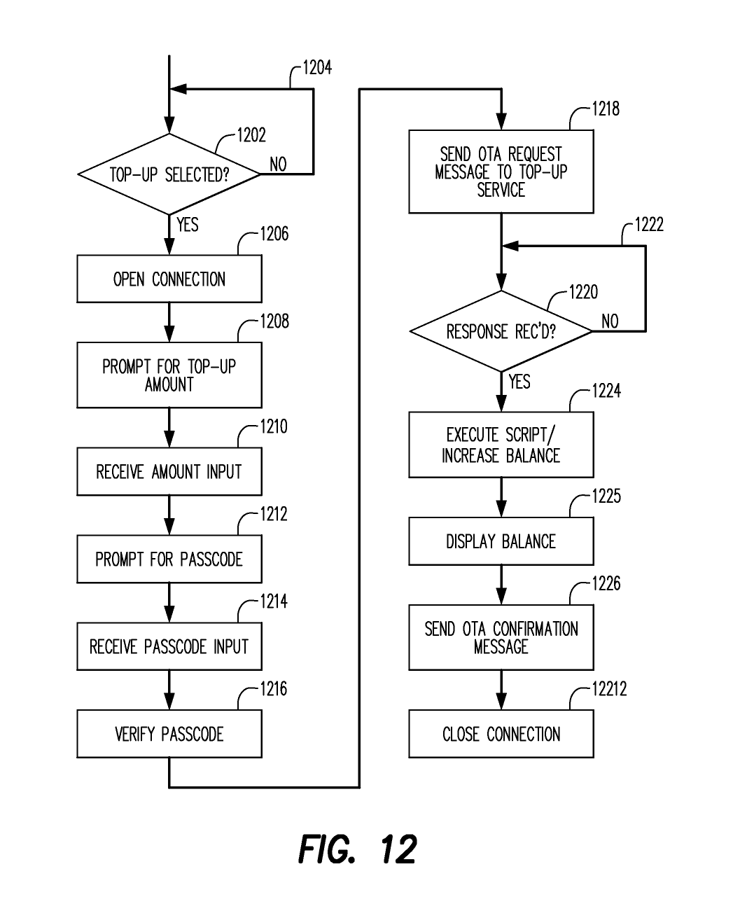

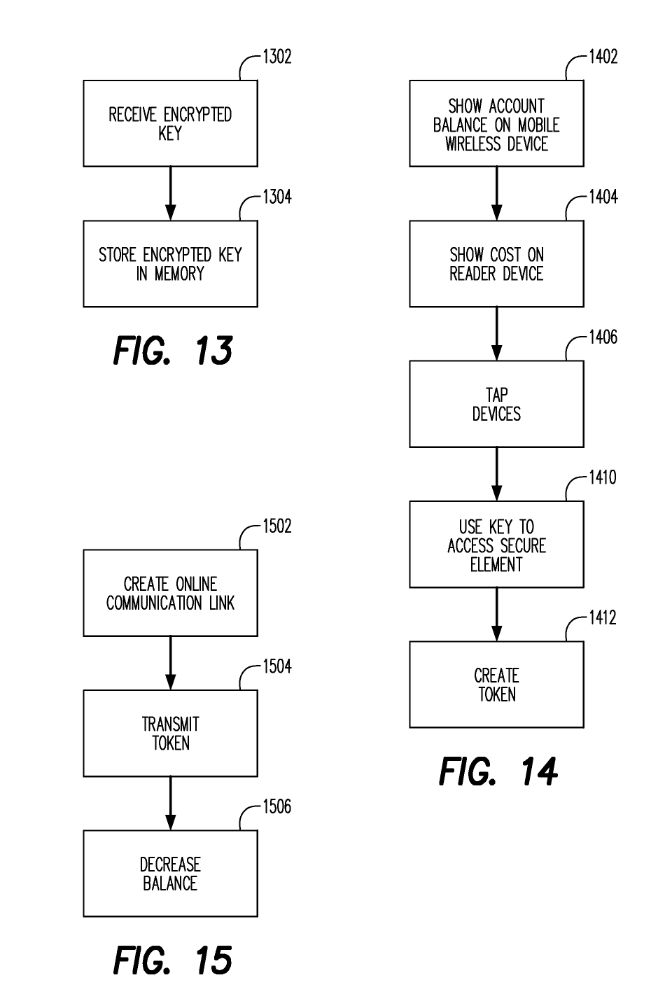

The process of flow 4 is depicted in FIGS. 13-14, where FIG. 13 illustrates a process implemented when the reader device 112 is preloaded with an encrypted key that allows the deliverer to access the secure element of the merchant's NFC-enabled wireless device and FIG. 14 illustrates a process implemented when merchandise delivery is made and the settlement of funds takes place.

In FIG. 13, at step 1302 the reader device 112 receives an encrypted key from the program manager 102 (FIG. 1) using wireless communications. In this example, the distributor has received an order from the merchant and has verified that the merchant's prepayment account for the distributor has sufficient funds to pay for the delivery. The encrypted key may require that a deliverer authenticate itself to the reader device before the encrypted key is decrypted by software on the reader device. The software may only allow the encrypted key to be decrypted and used once during a specified time period to protect the security of the secure element on the merchant's NFC-enabled wireless device 108.

The process advances to step 1304. In step 1304 the encrypted key is stored in memory to be used in an offline transaction with the merchant's NFC-enabled wireless device.

In the example process depicted in FIG. 14, at step 1402 the deliverer inspects the display of the merchant's NFC-enabled mobile device 108 to verify that the available balance of the merchant's prepayment account for the distributor has sufficient funds to pay for the delivery.

The process advances to step 1404. In process step 1404, the deliverer shows the merchant the number of units delivered and the total cost of the delivery.

The process advances to step 1406. In step 1406, at the time of delivery the deliverer “taps” the merchant's NFC-enabled wireless device to initiate the settlement of funds, i.e., an offline transaction that indicates a transfer of funds between the merchant's prepayment account for the distributor to the account of the distributor. The merchant can authorize the transaction by entering its PIN into the NFC-enabled wireless device before the NFC communication begins.

The process advances to step 1408. In step 1408 the processor of the reader device decrypts the encrypted key previously downloaded.

The process advances to step 1410. In process step 1410 the reader device uses the decrypted key to access the secure device of the NFC-enabled wireless device 108 and decrease the available balance by the cost of the merchandise delivered.

The process advances to step 1412. In process step 1412 the decrypted key is used to create an encrypted token in the memory of the reader device storing the new balance for the merchant's prepayment account and information identifying the merchant's prepayment account.

In flow 5, as depicted in FIG. 15, funds are cleared post merchant delivery.

In the example process depicted in FIG. 15, at step 1502 the reader devices 112 goes online to form a communication link with the program manager computer 102 of FIG. 1.

The process advances to step 1504. In step 1504 the reader device 112 transmits the token holding the amount that the merchant's prepayment account with the distributor was decreased and prepayment account identification data.

The process advances to step 1506. In step 1506 the transaction clearing application 214 on the issuer back-office server 199 (FIG. 2) decreases the balance in the merchant's prepayment account for the distributor by the amount indicated in the transmitted token.

Reference was made in the above discussion to communication between the NFC-enabled mobile device and the reader device via NFC. However, other types of communication are also possible including the EMV standard or in accordance with the well-known PayPass standard utilized in the U.S. Other types of prepaid transaction systems could be employed in alternative example embodiments.

The payment application in the NFC-enabled mobile device may maintain a log of all offline purchase transactions and reload transactions performed by the mobile device. This log may be accessible to the user via the user interface and the midlet.

Although the previous discussion has indicated that the payment application may be implemented in accordance with the M/Chip 4 Select standard, this is only one example of possible implementations of the payment application. In alternative embodiments of the invention, other types of payment applications may be employed.

In addition to the above-described functionality for offline purchase transactions, the NFC-enabled mobile device may in some embodiments also include functionality for engaging in online payment card system transactions, in substantially the same manner as a contactless credit or debit card.

As used herein and in the appended claims, the term “computer” should be understood to encompass a single computer or two or more computers in communication with each other.

As used herein and in the appended claims, the term “processor” should be understood to encompass a single processor or two or more processors in communication with each other.

As used herein and in the appended claims, the term “memory” should be understood to encompass a single memory or storage device or two or more memories or storage devices.

As used herein and in the appended claims, the term “OTA” or “over-the-air” should be understood to refer to an exchange of data messages via at least one mobile telephone network, and more specifically calls for transmission of data (in either or both directions) between a mobile telephone and a cellular communications base station.

The flow charts and descriptions thereof herein should not be understood to prescribe a fixed order of performing the method steps described therein. Rather, the method steps may be performed in any order that is practicable.

As used herein and in the appended claims, the term “payment system account” includes a credit card account or a deposit account that the account holder may access using a debit card. The terms “payment system account” and “payment account” are used interchangeably herein. The term “payment account number” includes a number that identifies a payment system account or a number carried by a payment device, or a number that is used to route a transaction in a payment system that handles debit card and/or credit card transactions.

As used herein and in the appended claims, the term “prepaid” includes “pre-authorized”. Accordingly, a prepaid payment capability may or may not imply linkage to an underlying account.

As used herein and in the appended claims, the term “payment system” refers to a system for handling purchase transactions and related transactions and operated under the name of MasterCard, Visa, American Express, Diners Club, Discover Card or a similar system. In some embodiments, the term “payment system” may be limited to systems in which member financial institutions issue payment card accounts to individuals, businesses and/or other organizations.

Although the present invention has been described in connection with specific exemplary embodiments, it should be understood that various changes, substitutions, and alterations apparent to those skilled in the art can be made to the disclosed embodiments without departing from the spirit and scope of the invention as set forth in the appended claims.

What is claimed is:

1. A method, performed by a processor coupled to an over-the-air communication system, comprising:
receiving an encrypted over-the-air message from a mobile wireless device requesting that the balance of a merchant's prepayment account for a distributor be reloaded by a requested amount, where the mobile wireless device stores the balance in a secure element holding data encrypted by a key;
authorizing a reload of the merchant's prepayment account for the distributor;
transmitting an encrypted over-the-air message to the mobile wireless device to enable the mobile wireless device to increase the balance of the merchant's prepayment account for the distributor by the requested amount where the wireless mobile device is able to display the balance of the merchant's prepayment account for the distributor;
notifying the distributor that the balance of the merchant's prepayment account for the distributor has been increased by the requested amount so that the distributor can authorize an unscheduled delivery to the merchant;
transmitting an over-the-air message including an encrypted version of the key to a reader device used by delivery personnel acting on behalf of the distributor so that the reader device can access the secure element of the mobile wireless device using offline near field communication to alter the balance of the merchant's prepayment account for the distributor;
receiving a settlement over-the-air message from a reader device indicating an amount to be deleted from the balance of the merchant's prepayment account for the distributor that reflects the cost of merchandise delivered by delivery personnel on behalf of the distributor, where the distributor has decrypted the received encrypted key and accessed the secure element of the mobile wireless device to decrease the balance of the merchant's prepayment account for the distributor stored in the secure element by the cost of merchandise delivered.

2. The method of claim 1 where receiving an encrypted over-the-air message further comprises:
receiving authentication information processed to authenticate a requestor prior to authorizing a reload.

3. The method of claim 1 further comprising:
requesting authorized funds be transferred from a merchant acquirer.

4. The method of claim 1 further comprising:
sending a message to the mobile wireless device indicating an amount of money transferred to the distributors account.

5. A system comprising:
means for receiving an encrypted over-the-air message from a mobile wireless device requesting that the balance of a merchant's prepayment account for a distributor be reloaded by a requested amount, where the mobile wireless device stores the balance in a secure element holding data encrypted by a key;
means for authorizing a reload of the merchant's prepayment account for the distributor;
means for transmitting an encrypted over-the-air message to the mobile wireless device to enable the mobile wireless device to increase the balance of the merchant's prepayment account for the distributor by the requested amount where the wireless mobile device is able to display the balance of the merchant's prepayment account for the distributor;
means for notifying the distributor that the balance of the merchant's prepayment account for the distributor has been increased by the requested amount so that the distributor can authorize an unscheduled delivery to the merchant;
means for transmitting an over-the-air message including an encrypted version of the key to a reader device used by delivery personnel acting on behalf of the distributor so that the reader device can access the secure element of the mobile wireless device using offline near field communication to alter the balance of the merchant's prepayment account for the distributor;
means for receiving a settlement over-the-air message from a reader device indicating an amount to be deleted from the balance of the merchant's prepayment account for the distributor that reflects the cost of merchandise delivered by delivery personnel on behalf of the distributor, where the distributor has decrypted the received encrypted key and accessed the secure element of the mobile wireless device to decrease the balance of the merchant's prepayment account for the distributor stored in the secure element by the cost of merchandise delivered.

6. The system of claim 5 where means for receiving an encrypted over-the-air message further comprises:
means for receiving authentication information processed to authenticate a requestor prior to authorizing a reload.

7. The system of claim 5 further comprising:
means for requesting authorized funds be transferred from a merchant acquirer.

8. The system of claim 5 further comprising:
means for sending a message to the mobile wireless device indicating an amount of money transferred to the distributors account.

9. A computer comprising:
a processor; and
a memory in communication with the processor, the memory storing program instructions, the processor operative with the program instructions to:
receive an encrypted over-the-air message from a mobile wireless device requesting that the balance of a merchant's prepayment account for a distributor be reloaded by a requested amount, where the mobile wireless device stores the balance in a secure element holding data encrypted by a key;
authorize a reload of the merchant's prepayment account for the distributor;
transmit an encrypted over-the-air message to the mobile wireless device to enable the mobile wireless device to increase the balance of the merchant's prepayment account for the distributor by the requested amount where the wireless mobile device is able to display the balance of the merchant's prepayment account for the distributor;
notify the distributor that the balance of the merchant's prepayment account for the distributor has been increased by the requested amount so that the distributor can authorize an unscheduled delivery to the merchant;
transmit an over-the-air message including an encrypted version of the key to a reader device used by delivery personnel acting on behalf of the distributor so that the reader device can access the secure element of the mobile wireless device using offline near field communication to alter the balance of the merchant's prepayment account for the distributor;
receive a settlement over-the-air message from a reader device indicating an amount to be deleted from the balance of the merchant's prepayment account for the distributor that reflects the cost of merchandise delivered by delivery personnel on behalf of the distributor, where the distributor has decrypted the received encrypted key and accessed the secure element of the mobile wireless device to decrease the balance of the merchant's prepayment account for the distributor stored in the secure element by the cost of merchandise delivered.

10. The computer of claim 9 wherein the processor is further operative to:
receive authentication information processed to authenticate a requestor prior to authorizing a reload.

11. The computer of claim 9 wherein the processor is further operative to:
request authorized funds be transferred from a merchant acquirer.

12. The computer of claim 9 wherein the processor is further operative to:
send a message to the mobile wireless device indicating an amount of money transferred to the distributors account.

13. An article of manufacture comprising:
a computer readable medium having computer readable program code means embodied therein for receiving an encrypted over-the-air message from a mobile wireless device requesting that the balance of a merchant's prepayment account for a distributor be reloaded by a requested amount, where the mobile wireless device stores the balance in a secure element holding data encrypted by a key;
computer readable program code means embodied therein for authorizing a reload of the merchant's prepayment account for the distributor;
computer readable program code means embodied therein for transmitting an encrypted over-the-air message to the mobile wireless device to enable the mobile wireless device to increase the balance of the merchant's prepayment account for the distributor by the requested amount where the wireless mobile device is able to display the balance of the merchant's prepayment account for the distributor;
computer readable program code means embodied therein for notifying the distributor that the balance of the merchant's prepayment account for the distributor has been increased by the requested amount so that the distributor can authorize an unscheduled delivery to the merchant;
computer readable program code means embodied therein for transmitting an over-the-air message including an encrypted version of the key to a reader device used by delivery personnel acting on behalf of the distributor so that the reader device can access the secure element of the mobile wireless device using offline near field communication to alter the balance of the merchant's prepayment account for the distributor;
computer readable program code means embodied therein for receiving a settlement over-the-air message from a reader device indicating an amount to be deleted from the balance of the merchant's prepayment account for the distributor that reflects the cost of merchandise delivered by delivery personnel on behalf of the distributor, where the distributor has decrypted the received encrypted key and accessed the secure element of the mobile wireless device to decrease the balance of the merchant's prepayment account for the distributor stored in the secure element by the cost of merchandise delivered.

14. The article of manufacture of claim 13 further comprising:
computer readable program code means embodied therein for receiving authentication information processed to authenticate a requestor prior to authorizing a reload.

15. The article of manufacture of claim 13 further comprising:
computer readable program code means embodied therein for requesting authorized funds be transferred from a merchant acquirer.

16. The article of manufacture of claim 13 further comprising:
computer readable program code means embodied therein for sending a message to the mobile wireless device indicating an amount of money transferred to the distributors account.
